(19) United States
(12) Patent Application Publication
(10) Pub. No.: US 2014/0064756 A1
(43) Pub. Date: Mar. 6, 2014

(54) IMAGE FORMING APPARATUS AND METHOD

(71) Applicants: Hiroyuki SUGIYAMA, Kanagawa (JP); Jun YURA, Kanagawa (JP); Yukiko IWASAKI, Kanagawa (JP); Jun SHIORI, Kanagawa (JP); Masaki SUKESAKO, Kanagawa (JP); Takuya SUGANUMA, Kanagawa (JP); Kazuaki KAMIHARA, Tokyo (JP); Hironobu TAKESHITA, Kanagawa (JP)

(72) Inventors: Hiroyuki SUGIYAMA, Kanagawa (JP); Jun YURA, Kanagawa (JP); Yukiko IWASAKI, Kanagawa (JP); Jun SHIORI, Kanagawa (JP); Masaki SUKESAKO, Kanagawa (JP); Takuya SUGANUMA, Kanagawa (JP); Kazuaki KAMIHARA, Tokyo (JP); Hironobu TAKESHITA, Kanagawa (JP)

(21) Appl. No.: 13/960,031

(22) Filed: Aug. 6, 2013

(30) Foreign Application Priority Data
Sep. 6, 2012 (JP) 2012-196058

(51) Int. Cl. G03G 15/00

(52) U.S. Cl. CPC G03G 15/55; G03G 13/00
USPC 399/44

(57) ABSTRACT

An image forming apparatus capable of executing continuous image forming operation forming images on more than one page includes a temperature detector that detects internal or surrounding temperature of a developing device correspondingly changing to temperature of a developer bearer. A temperature information acquiring device acquires information of ambient temperature outside of the image forming apparatus. A controller switches a current operation mode to an intermittent image forming operation mode intermittently including a braking time period not to allow image formation and cancels the intermittent image forming operation mode in accordance with detection result of the temperature detector. The intermittent image forming operation mode allowed to continuously form images only on a prescribed limited number of sheets. The controller varies the braking time period in accordance with the ambient temperature detected by the temperature information acquiring device.

### CROSS-REFERENCE TO RELATED APPLICATION

This patent application is based on and claims priority pursuant to 35 U.S.C. §119 to Japanese Patent Application No. 2012-196058, filed on Sep. 6, 2012 in the Japan Patent Office, the entire disclosure of which is hereby incorporated by reference herein.

### BACKGROUND

1. Technical Field

This invention relates to an image forming apparatus, such as a copier, a printer, a facsimile, etc., capable of continuously executing image forming operation.

2. Related Art

Conventionally, in an image forming apparatus employing electrophotography, during continuous printing of a large number of copies an image forming unit of the apparatus is continuously driven for a long time. Consequently, the temperature of the image forming apparatus and/or parts included in the image forming apparatus rises. Typically, the temperature of the image forming apparatus and/or the parts is controlled so as not to exceed a certain level by using a cooling fan and a duct or the like. In particular, a high-speed image forming apparatus conventionally has an air conditioner to control the interior temperature of the apparatus.

It is also known that in an image forming apparatus in which temperature of a fixing roller locally rises when a small-sized sheet is continuously fed thereto, the temperature of the fixing roller is directly monitored to temporarily lengthen the interval between successive sheets of paper or to smooth out any unevenness in the temperature of the fixing roller.

Thus, for example, JP-2010-134407-A discloses an image forming apparatus that controls the temperature of a developing motor without directly detecting the temperature thereof. Specifically, temperature fluctuation of the developing motor is calculated in accordance with an operating mode of the image forming apparatus, and a power off time period (i.e., a time when power supply is turned off) is estimated in accordance with the fluctuation in temperature of a fixing-thermistor. Further, the temperature fluctuation of the developing motor is corrected in accordance with the power off time period, and an estimated temperature of the developing motor is determined by adding ambient temperature to the thus-corrected temperature fluctuation of the developing motor.

Further, in the image forming apparatus of JP-2010-134407-A, when the thus-estimated temperature of the developing motor exceeds 100 degrees Celsius, image formation is intermittently interrupted until the temperature of the developing motor becomes less than 80 degrees Celsius.

Similarly, JP-2006-251504-A also discloses an image forming apparatus in which the number of dots of a toner image formed on an image bearer is initially counted. When the counted value exceeds a prescribed reference value, a developing roller stops rotation for a prescribed time period to decrease the temperature of a toner layer formed on the developing roller to prevent toner from adhering to a toner regulatory member even when a great amount of toner is consumed. Continuous image forming operation is executed thereafter.

However, in an image forming apparatus that cools interior temperature down with the above-described conventional cooling fan and/or duct, the extent of the cooling down is limited by such constraints as scale, configuration, layout of the image forming apparatus, or the like.

Further, depending on a section possibly raising a problem of temperature increase in the conventional image formation apparatus, temperature thereof may not be directly monitored and is generally uncontrollable. In particular, when an image forming unit with a developing device is driven for a long time, and accordingly the temperature of a sliding section, such as a bearing, etc., included in the developing device and/or developer itself considerably increases, developer (e.g., toner) sometimes melts in the developing device.

However, it is difficult to directly monitor the temperature of the sliding section and just the developer. Further, the image forming apparatus disclosed in JP-2010-134407-A may not prevent the toner borne on the developing roller from melting due to excessive increase in temperature of the toner in the developing device.

Further, in the image forming apparatus of JP-2006-251504-A, when the number of dots of the toner image is relatively small, the temperature of the sliding section, such as the bearing, etc., included in the developing device and the developing device itself considerably increases, and the problem of toner melting in the developing device may not be solved.

### SUMMARY

Accordingly, the present invention provides a novel image forming apparatus capable of executing continuous image forming operation forming images on more than one page. Such an image forming apparatus includes a latent image forming device to form a latent image on an image bearer, a developer bearer to bear developer, and a developing device to develop the latent image borne on the image bearer with developer borne on the developer bearer. A temperature detector is provided to detect internal or surrounding temperature of the developing device correspondingly changing to temperature of the developer bearer. A temperature information acquiring device is provided to acquire information of ambient temperature outside of the image forming apparatus. A controller is provided to either switch a current operation mode to an intermittent image forming operation mode allowed to execute intermittent image forming operation intermittently including a braking time period not allow the image formation or cancel the intermittent image forming operation mode in accordance with detection result of the temperature detector. The intermittent image forming operation mode is allowed to execute continuous image formation only on a prescribed limited number of sheets. The controller varies the braking time period in accordance with the ambient temperature detected by the temperature information acquiring device.

According to another aspect of the present invention, a method for forming an image in an image forming apparatus includes the steps of: forming a latent image on an image bearer; bearing developer; developing the latent image borne on the image bearer with developer borne on a developer bearer; and detecting internal or surrounding temperature of the developing device changing corresponding to temperature of the developer bearer using a temperature detector. The method further includes the steps of acquiring information of ambient temperature outside of the image forming apparatus using a temperature information acquiring device; switching an operation mode of the image forming apparatus to an intermittent image forming operation mode; and allowing intermittent image forming operation intermittently including a braking time period during which image formation in the intermittent image forming operation mode is prohibited. The method further includes the steps of continuously forming images on a prescribed limited number of sheets in the intermittent image forming operation mode; varying the braking time period in accordance with the ambient temperature information acquired by the temperature information acquiring device; and cancelling and switching the intermittent image forming operation mode to a normal operation mode to form images on a prescribed unlimited number of sheets in accordance with detection result of the temperature detector.

### BRIEF DESCRIPTION OF THE DRAWINGS

A more complete appreciation of the present invention and many of the attendant advantages thereof will be more readily obtained as substantially the same becomes better understood by reference to the following detailed description when considered in connection with the accompanying drawings, wherein:

FIG. 1 is a schematic diagram illustrating an overall configuration of a printer as one example of an image formation apparatus according to one embodiment of the present invention;

FIG. 2 is a schematic diagram illustrating an exemplary configuration of a yellow image forming unit utilized in the printer;

FIG. 3 is a perspective view of the yellow image forming unit;

FIG. 4 is a functional block diagram illustrating a principal part of a control system included in the printer;

FIG. 5 is a graph that illustrates an exemplary detected temperature T of a developing device as time elapses when an intermittent printing mode and a normal printing mode are subjected to transition control;

FIG. 6 is a chart illustrating a braking time period S inserted between two successive continuously printable sheet number limited jobs in the intermittent printing operation mode;

FIG. 7 is graph illustrating an exemplary aspect when detected temperature of a temperature sensor exceeds forty degrees Celsius once, and a current mode is switched to the intermittent printing mode (i.e., intermittent printing operation starts) while the developing device loses temperature and cools down;

FIG. 8 is a graph that illustrates a relation between ambient temperature and the braking time period S;

FIG. 9 is a graph that illustrates a relation between detection temperature of the temperature sensor and that of the developing device obtained when a finisher is detached and attached to the printer;

FIG. 10 is a graph that illustrates a relation between a detection temperature of the temperature sensor and that of the developing device obtained when a monochromatic mode (BW (Black and White mode)) and a full color mode (FC (Full-Color mode)) are utilized; and

FIG. 11 is a graph that illustrates a relation between a detection temperature of the temperature sensor and that of the developing device when the number of fans currently running in the printer varies.

### DETAILED DESCRIPTION

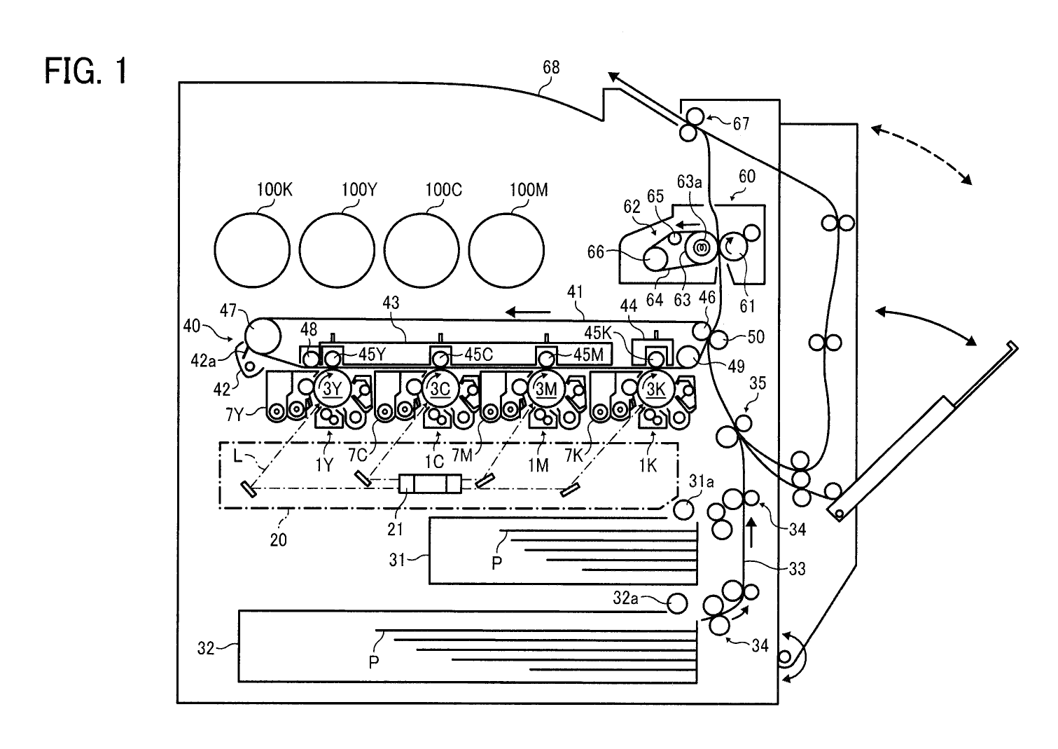

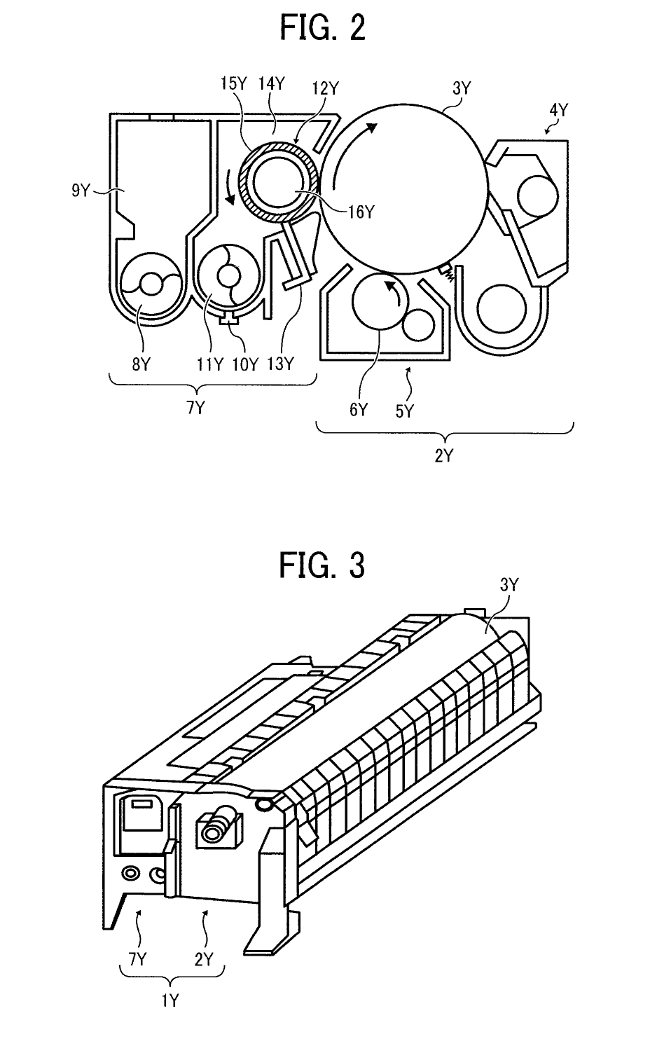

Referring now to the drawings, wherein like reference numerals designate identical or corresponding member throughout the several views thereof and in particular to FIGS. 1 to 3, an overall configuration of a printer as one example of an image formation apparatus according to one embodiment of the present invention is described. FIG. 2 illustrates an exemplary configuration of a yellow color image forming unit 1Y utilized in the printer of FIG. 1. FIG. 3 is a perspective view illustrating a yellow image forming unit 1Y.

As shown in FIG. 1, a printer has four image forming units 1Y, 1C, 1M, and 1K to produce yellow, magenta, cyan and black (hereafter referred to as Y, C, M, and K) toner images, respectively. These image forming units 1Y, 1C, 1M, and 1K use color toner particles of Y toner, C toner, M toner, and K toner different from each other as the image-forming substances to form images, respectively. However, other than that, these image forming units 1Y, 1C, 1M, and 1K have substantially the same configurations to each other. To typically described the image formation unit 1Y that produces the Y toner image as one example, the image forming unit 1Y has a photoconductor unit 2Y composed of a drum-shaped photoconductive member 3Y as a latent image bearer and a developing unit 7Y as a developing means to develop a latent image borne on the photoconductive member 3Y as shown in FIG. 2. These respective photoconductor unit 2Y and developing unit 7Y are integral and are detachably attachable to a printer body as an image forming unit 1Y as shown in FIG. 3. However, when these units 2Y and 7Y are removed from the printer body, the developing unit 7Y unit is further detachable from the photoconductor unit 2Y.

Blow the image forming units 1Y, 1C, 1M, and 1K in the drawing, an optical writing unit 20 is disposed as one of latent image forming devices. Based on image information, the optical writing unit 20 emits a laser beam L to the uniformly charged photoconductive members 3Y, 3C, 3M, and 3K in the respective image forming units 1Y, 1C, 1M, and 1K. Thus, the electrostatic latent images Y, C, M, and K are formed on the respective photoconductive members 3Y, 3C, 3M, and 3K. In the optical writing unit 20, the laser beam L originated from a light source is deflected by a polygonal mirror 21 driven and rotated by a motor, and at the same time illuminates the photoconductive member 3Y, 3C, 3M, and 3K via multiple optical lenses and mirrors. In lieu of such a configuration, however, prescribed optical light scanning can be executed using an LED array.

Further, as shown in FIG. 1, below the optical writing unit 20, vertically overlapping first and second sheet cassettes 31 and 32 are disposed each to supply a recording sheet P as a recording medium. In each of these sheet feeding cassettes, the multiple recording sheets P as the recording media are housed in a bunch state (i.e., a stack of multiple recording sheets). On the top of the multiple recording sheet P, a first sheet-feeding roller 31a and a second sheet-feeding roller 32a are positioned to border them, respectively. When the first sheet feeding roller 31a is driven and rotated counterclockwise in the drawing by a driving device, not shown, the recording sheet P located at the top of the multiple recording sheets P housed in the first sheet feeding cassette 31 is discharged toward a sheet feeding channel 33 vertically disposed on the right side of the sheet feeding cassette 31 in the drawing. When the second sheet-feeding roller 32a is driven and rotated counterclockwise in the drawing by a driving device, not shown, the recording sheet P located at the top of the multiple recording sheets P housed in the second sheet-feeding cassette 32 is discharged toward the sheet-feeding channel 33. Multiple conveying rollers 34 are provided in the feed channel 33, and the recording sheet P sent to the sheet-feeding channel 33 is conveyed from lower to upper sides in the drawing in the sheet-feeding channel 33 while being pinched between these multiple conveying rollers 34.

Further, a pair of registration rollers 35 is disposed at the end of the sheet-feeding channel 33. The pair of registration rollers 35 immediately temporarily stops its own rotation when sandwiching the recording sheet P coming from the pair of conveying rollers 34 between these pair of registration rollers 35. The pair of registration rollers 35 then pumps out the recording sheet P toward the later described secondary transfer nip at an appropriate time.

Above the image forming units 1Y, 1C, 1M, and 1K in the drawing, a transfer unit 40 as a transfer device is provided. The transfer unit 40 includes an intermediate transfer belt 41 stretched endless moving counterclockwise in the drawing as an intermediate transfer member. Other than the intermediate transfer belt 41, the transfer unit 40 further includes a belt-cleaning unit 42, a first bracket 43, and a second bracket 44 or the like. Further, four primary transfer rollers 45Y, 45C, 45M, and 45K, a secondary transfer backup roller 46, a driving roller 47, an auxiliary roller 48, a tension roller 49 or the like are also provided as well as in the transfer unit 40. Thus, the intermediate transfer belt 41 endlessly moves counterclockwise in the drawing while being stretched by these total eight rollers as the driving roller 47 rotates. These four primary transfer rollers 45Y, 45C, 45M, and 45K respectively form primary transfer nips by sandwiching this endlessly moving intermediate transfer belt 41 therebetween incorporating with the photoconductors 3Y, 3C, 3M, and 3K. Further, a transfer bias having an opposite polarity (e.g. positive polarity) to that of toner is applied onto a back side surface of the intermediate transfer belt 41 (i.e., an inner circumferential surface of a loop of the intermediate transfer belt 41). In the process of continuously passing the primary transfer nips for the respective component colors Y, C, M, and K as the intermediate transfer belt 41 endlessly moves, the Y, C, M, and K toner images borne on the respective photoconductive members 3Y, 3C, 3M, and 3K are primarily transferred and overlaid on a front side of the intermediate transfer belt 41. This allows the intermediate transfer belt 41 to form a four-color superimposed toner image (hereinafter referred to as a four-color toner image) thereon.

The secondary transfer backup roller 46 constituting the secondary transfer device and the secondary transfer roller 50 disposed outside the loop of the intermediate transfer belt 41 collectively sandwich the intermediate transfer belt 41 therebetween, so that the secondary transfer backup roller 46 forms a secondary transfer nip therebetween. Further, the pair of registration rollers 35 sandwiching the recording sheet P therebetween sends out the recording sheet P toward the secondary transfer nip synchronizing with the four-color toner image borne on the intermediate transfer belt 41. The four-color toner image borne on the intermediate transfer belt 41 is secondarily transferred onto the recording sheet P at once in the secondary transfer nip under an impact of a secondary transfer electric field formed by applying a secondary transfer bias between the secondary transfer backup roller 46 and the secondary transfer roller 50 and nip pressure generated therein. Thus, due to a contrast with a white background of the recording sheet P, a full-color toner image is generated.

Subsequently, residual toner not transferred onto the recording sheet P even after the secondary transfer process and thus remaining at downstream of the secondary transfer nip on the intermediate transfer belt 41 is removed by a belt-cleaning unit 42. The belt cleaning unit 42 causes a cleaning blade 42a to contact the front surface of the intermediate transfer belt 41 and scrapes off and removes the transfer residual toner from the intermediate transfer belt 41.

Above the secondary transfer nip in the drawing, a fixing unit 60 as a fixing device is provided to fix the toner image borne on the recording sheet P. The fixing unit 60 has a pressing and heating roller 61 containing a heat source, such as a halogen lamp, etc., and a fixing belt unit 62. The fixing belt unit 62 has a fixing belt 64 as a fixing member, a heating roller 63 containing a heat source 63a, such as a halogen lamp, etc., a tension roller 65, and a driving roller 66. Thus, the endless fixing belt 64 is stretched by the heating roller 63, the tension roller 65, and the driving roller 66 thereby endlessly moving counterclockwise in the drawing. On the endlessly moving process, the endless fixing belt 64 is heated by the heating roller 63 from a backside thereof. At a winding point of the fixing belt 64 winding the heated roller 63 and heated in this way, the pressing and heating roller 61 borders the fixing belt 64 from its front surface side and is driven clockwise in the drawing. This allows the pressing and heating roller 61 and the fixing belt 64 to border each other and form a fixing nip therebetween.

A temperature sensor, not shown, is provided outside the loop of the fixing belt 64 opposed to the front surface thereof through a given gap secured therebetween to detect temperature of a surface of the fixing belt 64 right before the fixing nip. Detection result is subsequently sent to a fixing power source circuitry, not shown. The fixing power source circuit turns a power supply on/off to enable or disable the power supply to supply power to both of the heat sources 63a and 61a contained in the heating roller 63 and the pressing and heating roller 61, respectively, in accordance with the detection result of the temperature sensor. Hence, the surface temperature of the fixing belt 64 can be maintained at about one hundred forty degrees Celsius, for example.

Thus, the recording sheet P passing through the secondary transfer nip is sent into the fixing unit 60 after separating from the intermediate transfer belt 41. Subsequently, the recording sheet P is heated and pressed by the fixing belt 64 and the pressing and heating rollers 61 as well so that the full-color toner image is fused when it is nipped by the fixing nip formed in the fixing unit 60, and is further conveyed toward an upper side from a lower side in the drawing.

The recording sheet P subjected to the fixing processes in this way is discharged to an outside of the printer (i.e., the image forming apparatus) after passing through between a pair of sheet ejecting rollers 67. On an upper side of the housing of the printer body, there is formed a stacking unit 68. Thus, the recording sheet P expelled to the outside of the printer body by the pair of sheet ejecting rollers 67 is stacked continuously on the stacking unit 68. Further, four toner cartridges 100Y, 100C, 100M, and 100K accommodating Y, C, M, and K toner particles, respectively, are provided above the transfer unit 40. These color toner particles stored in the respective toner cartridges 100Y, 100C, 100M, and 100K are supplied to the developing devices 7Y, 7C, 7M, and 7K included in the image forming unit 1Y, 1C, 1M, and 1K from time to time. These toner cartridges 100Y, 100C, 100M, and 100K can be independently attachably detached to the printer body from the respective image forming units 1Y, 1C, 1M, and 1K.

As shown in FIG. 2, the photoconductor unit 2Y has the photoconductive member 3Y, the drum cleaner 4Y, a charge eliminator, not shown, a charger 5Y that provides electric charge to a surface of the photoconductive member 3Y as a charger. FIG. 2 shows an exemplary configuration of the charger 5Y employing a system to uniformly charge the photoconductive member 3Y by driving and rotating a discharge roller 6Y counterclockwise in the drawing at a position close to the photoconductive member 3Y while applying a charge bias thereto from a prescribed power source, not shown. However, instead of the charging roller 6Y, a charging brush bordering the photoconductive member 3y can be employed. Yet otherwise, another charger system 3Y, such as a scorotron charger, etc., which again uniformly charges the surface of the photoconductor 3Y can be also employed. In any way, the surface of the photoconductor 3Y uniformly charged by the charger 5Y receives scanning exposure of laser light emanating from the optical writing unit 20 and bears an electrostatic latent image of Y color formed thereon.

The developing unit 7Y includes a first developer container unit 9Y in which a first conveying screw 8Y is disposed. The developing unit 7Y also includes a second developer container unit 14Y, in which a toner density sensor 10Y as a toner density detector composed of a permeability magnetic sensor, etc., a second conveying screw 11Y, a developing roller 12Y, and a doctor blade 13Y as a developer regulatory member or the like are disposed. Even (not shown) in the drawing, in these two developer container units 9Y and 14Y, magnetic carrier and Y-color developer having toner with a negative electrostatic charge polarity are involved. A first conveying screw 8Y is driven and rotated by a driving device, not shown, and conveys the Y color developer stored in the first developer container unit 9Y in a direction perpendicular to a plane of the drawing from front to rear sides therein. Subsequently, the first conveying screw 8Y brings the Y color developer into the second developer container unit 14Y through a connecting hole, not shown, formed on a partition wall provided between the first-developer container unit 9Y and the second developer container unit 14Y.

Further, a second conveying screw 11Y in the second developer container unit 14Y is driven and rotated thereby conveying the Y color developer from the rear to front sides in the drawing. Toner density of the Y color developer is detected along the way of its transportation by a toner density sensor 10Y secured to the bottom of the first developer container unit 14Y. Above the second conveying screw 11Y, the developing roller 12Y is disposed parallel to the second conveying screw 11Y. The developing roller 12Y includes a developing sleeve 15Y composed of a nonmagnetic pipe driven counterclockwise as shown in the drawing with a magnetic roller 16Y being installed. The Y color developer conveyed by the second conveying screw 11Y is partially pumped up by magnetic force emanating from the magnetic roller 16Y onto a surface of the developing sleeve 15Y. Subsequently, the Y color developer is smoothed to establish a prescribed layer thickness thereof by a doctor blade 13Y disposed via a given gap between the developing sleeve 15Y serving as developer bearer. The Y-color developer is then conveyed up to a developing region facing the photoconductive member 3Y and toner therein adheres to an electrostatic latent image borne on the photoconductor 3Y there. By the adhesion, a Y color toner image is formed on the photoconductive member 3Y. The Y color developer thus having consumed the Y toner by such development is brought back onto the second conveyance conveying screw 11Y as the developing sleeve 15Y rotates. Subsequently, when the Y color developer is conveyed up to the front end in the drawing, it then returns back to the second developer container unit 9Y through a connecting hole, not shown.

Detection result of magnetic permeability of the Y-color developer by the toner density sensor 10Y is sent to a control unit, not shown, as a voltage signal. Because the magnetic permeability of the Y color developer indicates a relation with Y toner density of the Y color developer, the toner density sensor 10Y outputs a prescribed voltage corresponding to the Y toner density. The above-described control unit includes a memory, such as a RAM, etc., as a storage device, that stores data of Y, C, M, and K use Vtref values serving as targets to reach for output voltages outputted from the respective toner density sensors 10Y-K. In the typical Y use-developing unit 7Y, the output voltage outputted from the toner density sensor 10Y is compared with the Y color's Vtref, and a Y color's toner supplying system described later in detail is driven for a prescribed time period in accordance with the comparison result. With such driving control, a dosage of Y toner is supplied to the Y color developer stored in the first developer container unit 9Y, which has reduced the density of the Y toner by consuming the Y toner during the development. Consequently, density of the Y toner can be maintained within a given range in the second developer container unit 14Y. The same toner supply control may be carried out for the developer stored in the other color image forming units (1C, 1M, and 1K) as well.

Further, the Y toner image formed on the photoconductor 3Y is intermediately transferred onto the intermediate transfer belt 41. The drum cleaning unit 4Y removes toner remaining on the surface of the photoconductive member 3Y completing the intermediate transfer process. Hence, electric charge remaining on the surface of the photoconductor 3Y after the cleaning process applied thereto is removed by the charge eliminator (not shown). Thus, the surface of the photosensitive member 3Y is initialized by this elimination to be prepared for the next image formation. Similarly, the respective C, M, and K color toner images are formed on the photoconductors 3C, 3M, and 3K and are intermediately transferred onto the intermediate transfer belt 41 in the other color image forming units 1C, 1M, and 1K, respectively, as well as shown in FIG. 1.

Further, in the printer with the above-described configuration, a temperature sensor as a temperature detector, not shown, is installed either in the developing unit 7Y or around the developing unit 7Y in the body of the image formation apparatus (i.e., the printer). Specifically, the temperature sensor is installed at a prescribed position enabling detected temperature to indicate a high relation with temperature of an interior of the developing device. The temperature sensor thus detects temperature of either the interior of the developing device or the surrounding thereof correspondingly changing to temperature of the developing sleeve 15Y. The remaining color image forming units using other colors have the similar configurations to that of the Y color.

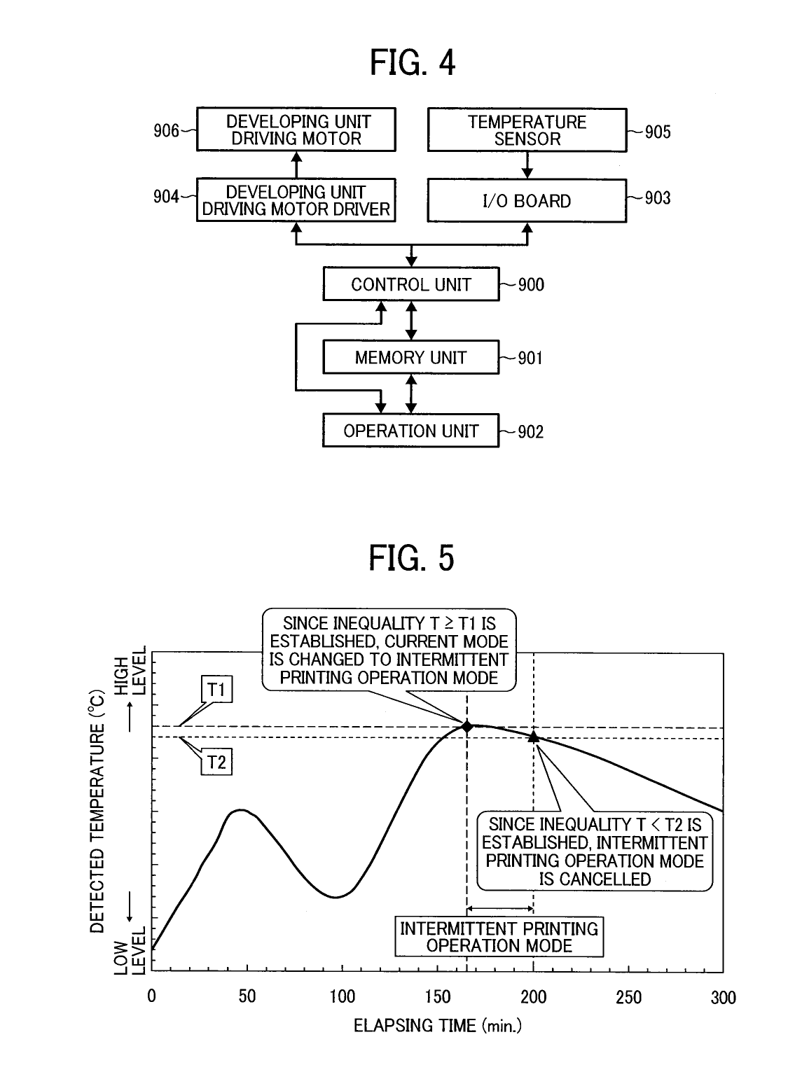

FIG. 4 is a functional block diagram illustrating a principal part of a control system included in the printer with the above-described configuration. As shown in FIG. 4, a control unit 900 is composed a CPU, a ROM, a RAM or the like as a controller, for example, and is connected to a storage unit 901 as a storage device, an operation unit 902 as an inputting device, an I/O board 903 as a temperature detected interface unit, and a development driving motor 904 as a developer-bearer driving unit or the like. The I/O board 903 controls the temperature sensor 905 (serving as the temperature detector disposed either in the developing unit 7 or around the developing unit 7Y provided in the body of the image formation apparatus) to conduct detection of temperature based on an instruction given by the control unit 900. The I/O board 903 then converts a voltage of a temperature detection signal (i.e., a detection voltage) outputted by the temperature sensor 905 into a digital signal and sends the digital signal to the control unit 900. The development driving motor driver 904 delivers a predetermined voltage or current to a development driving motor 906 serving as a power source for the developing roller 12 based on an instruction given by the control unit 900, and either rotates the developing sleeve 15 of the developing roller 12 at a given rotating velocity or turns on and off the rotation thereof. Further, the storage unit 901 is formed from a memory composed of semiconductor or the like, a magnetic disk, or an optical disk and the like, and stores data of temperature detected by the temperature sensor 905 and various setting data pieces, such as temperature thresholds T1 and T2, etc., indicating various controlling conditions as described later in detail. The data stored in the memory unit 901 can be written or read through the control unit 900. In addition, the operation unit 902 is composed of various buttons, a touch panel, and an LCD display as a display, available for a user to operate, and serves as an inputting device to enter the various controlling conditions. Thus, various data thus entered and set by an action of the user through the operation unit 902 are stored in the memory unit 901 through the control unit 900 and can be utilized to control various devices.

Furthermore, the printer of this embodiment has a temperature information-acquiring device to acquire information of ambient temperature outside of the printer. For example, the temperature information acquiring device is configurable from a temperature sensor, not shown, connected to the control unit 900 disposed in an outside of the printer. Data of the ambient temperature detected by the temperature sensor can be stored in the memory unit 901. Otherwise, the temperature information-acquiring device can be configured by either a communications interface unit that receives the data of ambient temperature from an external storage medium through communications. Yet otherwise, the temperature information-acquiring device can be configured by an operation unit 902 that enables a user to input the fata of ambient temperature.

Here, the control unit 900 can execute the below described various controlling and processing operations by loading and executing prescribed control program as described below. Specifically, first, the control unit 900 may instruct a developing roller to drive.

Secondly, the control unit 900 may calculate detection temperature in accordance with a voltage outputted by the temperature sensor. Thirdly, the control unit 900 may determine if a current mode is to be switched to an intermittent printing mode and execute prescribed control based on a result of the determination as described later in detail. Fourthly, the control unit 900 may set a braking time period S in accordance with outside temperature in an intermittent printing mode as described later in detail. Fifthly, the control unit 900 may switch a temperature threshold T1 in the intermittent printing mode as described below in detail.

Specifically, the control unit 900 controls an operating mode in accordance with temperature detected by the temperature sensor 905 as follows. That is, the temperature control unit 900 firstly provides a driving instruction to the developing roller to start driving. The temperature control unit 900 converts a voltage detected by the temperature sensor 905 into temperature (e.g. hereinafter referred to as T [degrees Celsius]). The control unit 900 then saves the data of the temperature T as a conversion result by storing it in the memory unit 901. At that time, the control unit 900 compares the currently detected temperature T with a first temperature threshold T1 preset and stored in the memory unit 901 when saving the data of the detection temperature T therein. When an inequality T≧T1 is established, the control unit 900 switches a current mode to a restricted image forming operation mode, in which the number of continuously printable sheets is restricted to be less than a given value P (hereinafter, referred to as an intermittent printing operation mode). In the intermittent printing operation mode, when continuous printing operation (i.e., image formation operation) to produce the total number of sheets Pi (>P) is requested and instructed, the developing unit 7 including the developing roller 12 stops operation for a given time period at every after a prescribed number of sheets P has been printed. Further, the image forming apparatus then enters a standby state to stop its image forming operation. That is, continuous printing operation (i.e., continuous image forming operation) of multiple numbers of sheets Pi runs intermittently not as instructed.

After switching to the intermittent printing mode, the control unit 900 compares the currently detected temperature T with a second temperature threshold T2 (<T1) preset and stored in the memory unit 901. When the inequality T<T2 is established, the above-described sheet number limitation only allowing the continuous image formation of the number of sheets P is removed, and the mode is switched and returns to the normal image forming operation mode which allows normal continuous printing operation (i.e., continuous image forming operation) (hereinafter, referred to as a normal printing mode). Specifically, in the normal printing mode, when continuous printing operation (i.e., image formation operation) of the total number of sheets Pi (>P) is requested and instructed, the image forming apparatus does not enter the standby state, in which the developing roller 12 stops operation for the given time period at every after the prescribed number of sheets P has been printed, and continuous printing operation of multiple numbers of sheets Pi (i.e., continuous image formation operation) is executed as ordered.

These temperature thresholds T1 and T2 utilized in this way to determine if the above-described intermittent printing mode and the normal printing mode are switched therebetween are stored in the memory unit 901. However, these temperature threshold values T1 and T2 already stored in the memory unit 901 can be changed by a user when she or he inputs new threshold temperature values T1 and T2 though the operation unit 902. In this way, the threshold temperature values T1 and T2 can be optionally set by operating the operation unit 902. Since this allows a user to freely set temperature threshold values T1 and T2 according to a practical situation and usage in a market, occurrence of problems, such as toner melting, etc., due to increase in temperature of the above-described developing roller 12 can be more likely reduced.

FIG. 5 is a chart that illustrates one example of temporal variations in detected temperature T of the developing device when switching control between these intermittent printing mode and the normal printing mode is executed. As shown in FIG. 5, when the normal printing operation mode capable of executing the continuous printing operation is set, and temperature T [degrees Celsius] detected by the temperature sensor 905 is the first temperature threshold T1 or more, the current mode is switched to the intermittent printing operation mode. Due to switching to the intermittent printing mode, when a printing request for continuously printing prescribed multiple sheets (i.e., total number of sheets Pi>P) is made, the intermittent printing operation is executed, in which only the limited number of sheets P are continuously printed and intermittently repeated. This increases downtime of the developing unit 7 for the total printing number of sheets Pi, and does not further increase or positively decrease the temperature of the developing unit 7. Further, when an interval (i.e., a waiting time) R, not shown, between a time when the developing unit 7 stops driving and a time when it resumes driving in the intermittent printing operation is appropriately changed by setting a prescribed appropriate value, the temperature of the developing unit 7 can be more effectively controlled. In any way, in the above-described intermittent printing mode, when the temperature T [degrees Celsius] detected by the temperature sensor 905 becomes less than the second temperature threshold T2 (<T1), the current mode is switched back to the normal printing operation mode.

Further, the given number of sheets P serving as a limitation to the number of continuously printable sheets and the interval R between the time when the developing unit 7 stops driving and that when it resumes driving as utilized in the above-described intermittent printing operation mode can be optionally set by a user by operating the operation unit 902 depending on its real-life situation and usage, so that a problem possibly caused by such temperature rising in the developing roller 12 can be likely more preferably reduced.

In any way, since it can be determined that the temperature of the developing unit 7 sufficiently drops when the temperature T [degrees Celsius] detected by the temperature sensor 905 becomes below the second temperature threshold T2 (<T1) in the above-described intermittent printing mode after that, the limitation to the number of continuously printable sheets is cancelled while the current mode is switched to the normal printing mode without the limitation to the number of continuously printable sheets again.

Further, as described earlier, the temperature thresholds T1 and T2 can be set to any values via the operation units 902. Thus, when a magnitude relation is changed to the inequality T1>T2, toner can likely prevent from melting possibly occurring when the (normally execute) continuous printing immediately starts after the limitation to the above-described number of continuously printable sheets is cancelled and accordingly temperature of the developing unit 7 rapidly increases.

Now, an exemplary braking time period S provided between printing jobs (i.e., image formation jobs) with the limitation to the number of printable sheets P in the above-described intermittent printing operating mode is described. It is the goal for the intermittent printing operation to either prevent increase or positively decrease the temperature of the developing unit 7 by lowering productivity of printing sheets. Specifically, in the intermittent printing operation, the number of continuously printable sheets is limited to the value P, and the continuous printing job request by a printing instruction to print the multiple sheets Pi is divided into a continuous printing job that executes the number of sheets P less than that of Pi (hereinafter, referred to as a continuously printable sheet number limited job). This can provide the downtime of the developing roller 12 of the developing unit 7 and decrease the temperature of the developing unit 7.

However, when an interval between the multiply divided continuously printable sheet number limited jobs is relatively short, the subsequent continuously printable sheet number limited job shortly comes up after the preceding continuously printable sheet number limited job is completed even when the mode is switched to the intermittent printing mode executing the above-described intermittent printing for the above-described purpose. Consequently, immediately after the preceding continuously printable sheet number limited job is completed and various motors serving as power sources in the printer stop operations, preparation for the subsequent continuously printable sheet number limited job starts while start driving the electric motors as well. Specifically, a sufficiently long braking time sometimes may not be secured for the motor that rotates and drives the developing roller 12 of the developing unit 7 depending on a situation. In particular, under a condition, such as high temperature environment (e.g., high ambient temperature) etc., in which the developing device hardly cools down, the developing unit 7 likely may not certainly prevent temperature increase only when the number of continuously printable sheets is limited.

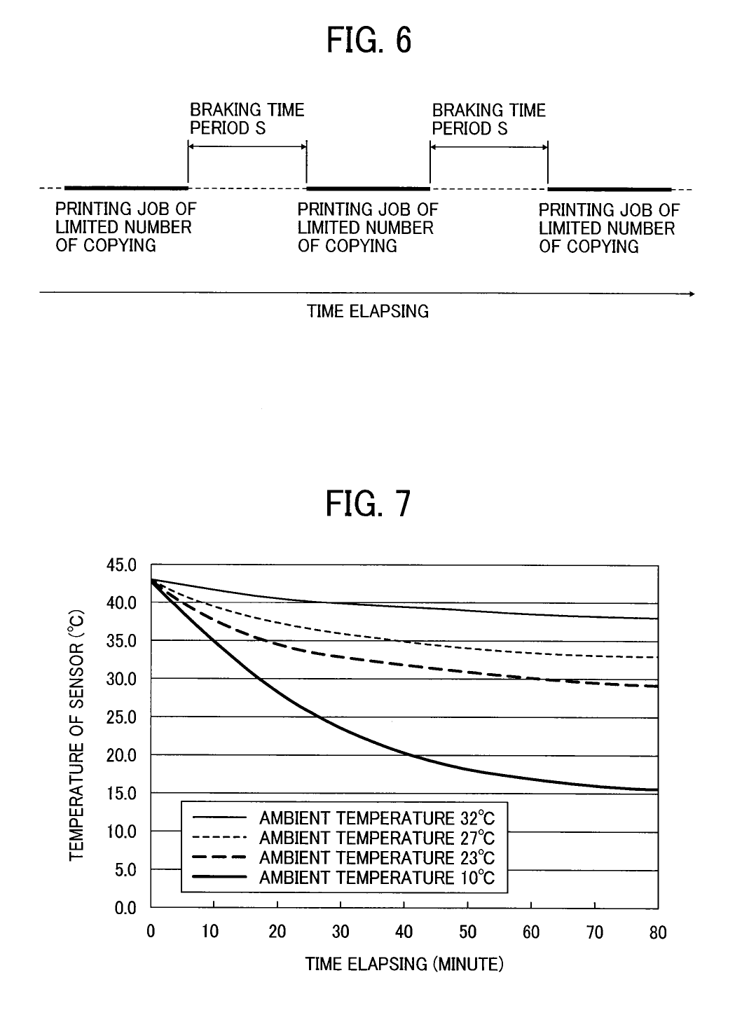

In this regard, according to another embodiment, a prescribed braking time period S, in which printing activity (i.e., image formation) is not executed, is provided between successive continuously printable sheet number limited jobs in the intermittent printing operation mode as shown in FIG. 6. In short, this can forcibly set the braking time not to drive nor rotate the developing roller 12 provided in the developing unit 7, and can effectively decrease temperature of the developing unit 7.

Now, an exemplary control manner of changing a length of the above-described braking time period S in accordance with the ambient temperature is described with reference to applicable drawings. FIG. 7 is a graph obtained by monitoring an aspect of the developing unit 7 that loses temperature and cools down after the printer is continuously driven and temperature detected by the temperature sensor 905 disposed near the developing unit 7 rises more about forty degrees Celsius, while a current mode is switched to the intermittent printing mode (i.e., the intermittent printing starts). As shown in FIG. 7, the intermittent printing operation is executed on conditions that the number of continuously printable sheets is four in a continuously printable sheet number limited job and the braking time period S is about thirty seconds and these are repeated. Hence, temperature change of the developing unit 7 is detected under four different ambient temperature conditions while executing the intermittent printing activity under the above-described conditions.

From FIG. 7, it can be understood that the lower the ambient temperature, the more quickly the developing unit 7 cools. Here, when temperature (i.e., interior temperature of the printer) detected by the temperature sensor 905 is about forty degrees Celsius, the current mode is switched to the intermittent printing mode, and intermittent printing operation is initiated. Subsequently, the intermittent printing mode is cancelled when the temperature sensor 905 is chilled down to about thirty-nine point nine degrees Celsius, and the current mode returns back to the normal printing mode to allow continuous sheet feeding as a normal printing mode. When the above-described intermittent printing mode is executed at ambient temperature of about 32 degrees Celsius, a time period when temperature (i.e., interior temperature of the printer) detected by the temperature sensor 905 decreases down to thirty-nine point nine degrees Celsius from 40 degrees Celsius amounts to about 60 seconds. Accordingly, the intermittent operating mode needs to be maintained for about 60 seconds. By contrast, when the ambient temperature is about 23 degrees Celsius, a time period when temperature (i.e., interior temperature of the printer) detected by the temperature sensor 905 decreases down to thirty-nine point nine degrees Celsius from 40 degrees Celsius amounts to about 10 seconds. Accordingly, the intermittent operating mode may be preferably maintained for about 10 seconds. Since the braking time period S in this intermittent printing mode of this embodiment is about 30 seconds, waiting time of about 20 seconds is likely wasted in environment of the ambient temperature of about 23 degrees Celsius.

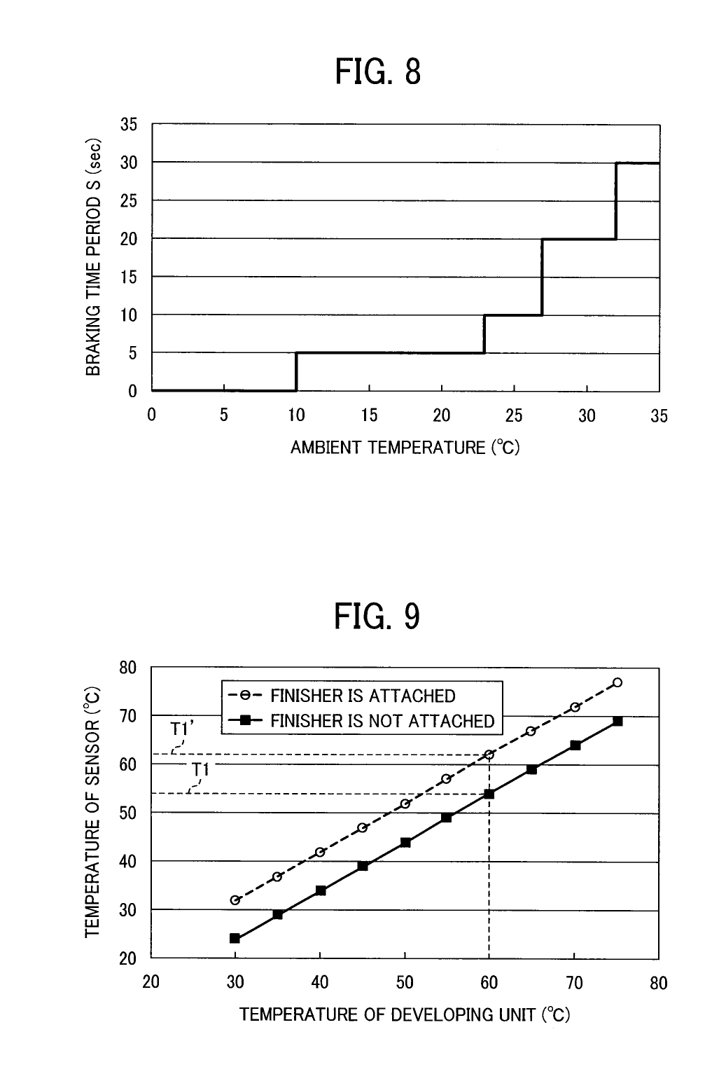

Here, a first table summarizes a relation between a time period when temperature detected by the temperature sensor 905 decreases from forty degrees Celsius to thirty-nine point nine degrees Celsius, ambient temperature, and a suitable braking time period S based on the temperature data shown in FIG. 7. FIG. 8 also graphically illustrates a relation between the ambient temperature and the braking time period S.

FIRST TABLE

| | Time period when Temperature | |
|---|---|---|
| | (Interior Temperature) detected | |
| | by Temperature Sensor decreases | |
| | from Forty Degrees Celsius to | |
| Ambient | Thirty-nine point nine Degrees | Braking Time |
| Temperature | Celsius | period S |
| Thirty-two | Sixty Seconds | Thirty Seconds |
| Degrees Celsius | | |
| Twenty-seven | Twenty Seconds | Twenty Seconds |
| Degrees Celsius | | |
| Twenty-three | Ten Seconds | Ten Seconds |
| Degrees Celsius | | |
| Ten | Five Seconds | Five Seconds |
| Degrees Celsius | | |

As shown in FIG. 8 and the first table, in a range of air temperature between less than 27 degrees Celsius and more than ten degrees Celsius, a time period when temperature (i.e., interior temperature of the printer) detected by the temperature sensor 905 decreases from forty degrees Celsius down to thirty-nine point nine degrees Celsius is equivalent to the corresponding braking time period S. Further, it is generally supposed to be considerably rare that temperature (i.e., interior temperature of the printer) detected by the temperature sensor 905 rises up to about forty degrees Celsius when ambient temperature ranges less than ten degrees Celsius. Accordingly, the braking time period S of zero seconds is given in such a range. Further, a time period of thirty seconds is insufficient for the braking time period S when the ambient temperature is near thirty-two degrees Celsius. Therefore, continuously printable sheet number limited job with the limitation to four sheets is repeated plural times while inserting the braking time period S of thirty seconds therebetween to decrease the temperature of the developing unit 7. When the temperature of the developing unit 7 is reduced thereafter, the intermittent printing operation mode is cancelled.

As described heretofore, by varying the braking time period S inserted in the intermittent printing mode in accordance with the ambient temperature, the temperature of the developing unit 7 is effectively reduced while substantially eliminating a waste of time.

Now, exemplary switching control operation of switching the temperature threshold T1 utilized in determining if a mode is switched to the above-described intermittent printing operation mode is hereinbelow described with reference to applicable drawings. The temperature sensor 905 is provided for the purpose of detecting the temperature inside the developing unit 7 or that of developer as described above. Since many models of the developing unit 7 are frequently manufactured as replaceable parts, the temperature sensor 905 is often installed close to the developing unit 7 in the body of the image forming apparatus. When the temperature sensor 905 is provided apart far from the developing unit 7, a relation between temperature detected by the temperature sensor 905 and that of the developing unit 7 likely becomes different depending various factors, such as airflow created around the temperature sensor 905, a type of an operational mode, setting temperature of a heat source for fixing, etc. In such a situation, an error arises in detecting temperature of the developing unit 7, so that temperature of the developing unit 7 is no longer proportionally (or correspondingly) sought in accordance with temperature detected by the temperature sensor 905. Further, the temperature sensor 905 generally includes an inherent detection error (for example, a detection error caused an error of resistance when a resistive element is utilized as a sensor). To deal with (i.e., compensate) the detection error, a designing margin needs to be given to the above-described temperature threshold T1. Consequently, the current mode needs to be switched to the above-described intermittent printing operation mode and the intermittent printing operation is to be started from a detection temperature lower than the temperature threshold T1, thereby degrading productivity of printing.

Hence, to minimize such productivity losses to the minimum, the detection error of the temperature sensor 905 possibly caused by the above-described various factors is preferably minimized as much as possible. For example, a condition (for example, existence or absence of a peripheral device, a type of an operating mode) that changes the relation between the temperature detected by the temperature sensor 905 and that of the developing unit 7 is checked, and the above-described temperature threshold T1 is changed in accordance with the condition to more precisely (i.e., timely) switch the current mode to the above-described intermittent printing operation mode.

FIG. 9 is a graph that illustrates an aspect of a relation between temperature detected by the temperature sensor 905 and that of the developing unit 7 in a different situation, specifically, whether or not a finisher is attached to the printer as the peripheral device. When the finisher is attached to the printer, airflow created in the interior of the printer is sometimes blocked and is directed differently therein.

Consequently, as shown in FIG. 9, depending on whether or not the finisher is attached to the printer, the relation between the temperature detected by the temperature sensor 905 and that of the developing unit 7 greatly become different from the other situation. Specifically, to prevent temperature of the developing unit 7 provided in the printer having the characteristics shown in FIG. 9 from becoming about sixty degrees Celsius, the temperature threshold T1 may be switched in accordance with the presence or absence of the finisher. To switch the temperature threshold T1, multiple setting values to be set to the temperature thresholds T1 are prepared previously, and one of them is chosen as a setting value to selectively set as the temperature threshold T1. The same goes in the below described various examples or modifications which similarly selectively set the setting value as the temperature threshold T1).

Now, as a first comparative example, a situation in which temperature control is executed regardless of whether or not a peripheral device (e.g., a finisher) is present is described.

When temperature of the developing unit 7 in the printer omitting the finisher reaches about sixty degrees Celsius, for example, temperature detected by the temperature sensor 905 ranges from about fifty-four degrees Celsius to about sixty-two degrees Celsius. Further, when the temperature detected by the temperature sensor 905 reaches fifty-four degrees Celsius, the temperature of the developing unit 7 cannot avoid from reaching about sixty degrees Celsius unless the intermittent printing operation runs. Thus, a current mode (i.e., the normal mode) needs to be switched to the intermittent printing operation mode and temperature-decreasing control is to be commenced to decrease the temperature of the developing unit 7.

By contrast, when the finisher is present, specifically attached to the printer, even if the temperature detected by the temperature sensor 905 indicates fifty-four degrees Celsius, actual temperature of the developing unit 7 is only about fifty-two degrees Celsius. Consequently, productivity ends up falling down by an amount corresponding to a difference in temperature of 8 degrees Celsius as a loss, if the current mode (i.e., the normal mode) is switched to the intermittent printing operation mode and temperature-decreasing control is commenced to decrease the temperature of the developing unit 7.

Now, a second example, in which it is considered whether or not a peripheral device (e.g., a finisher) is present is described. In this situation, a linear approximation shown in FIG. 9 is specified by the formula y=ax+b. More specifically, when the finisher is present, the formula (y=a′x+b′) is utilized. By contrast, when the finisher is absent, the formula (y=a′x+b) is utilized. In the formula, “y” represents temperature detected by the temperature sensor 905 while “x” represents that of the developing unit 7.

Thus, to control switching the current mode to the intermittent printing mode with the presence of the finisher, the formula y″=a′×sixty degrees Celsius+b′ is utilized. Whereas, when the finisher is absent, the formula y″=a×sixty degrees Celsius+b is utilized.

Further, when the finisher is present, the above-described value y′ (i.e., T1′ in the drawing) is set to the above-described temperature threshold T1. By contrast, when the finisher is absent, the above-described y″ (i.e., T1 in the drawing) is set to the above-described temperature threshold T1.

As understood from FIG. 9, when the finisher is present, the temperature threshold T1 (i.e., T1′ in the drawing) to be set is about sixty-two degrees Celsius. By contrast, when the finisher is absent, the temperature threshold T1 (i.e., T1 in the drawing) to be set is about fifty-four degrees Celsius.

As described heretofore, when the setting value set to the temperature threshold T1 is switched considering the presence or absence of the peripheral device as in the second example, an impact of the detection error of the temperature sensor 905 caused in accordance with the presence or absence of the peripheral device can be effectively minimized when compared with a situation not considering the presence or absence of the peripheral device as in the first example.

Further, the setting value set to the temperature threshold T1 may be similarly switched in accordance with the other various temperature relation factors other than existence or absence of the peripheral device as described below.

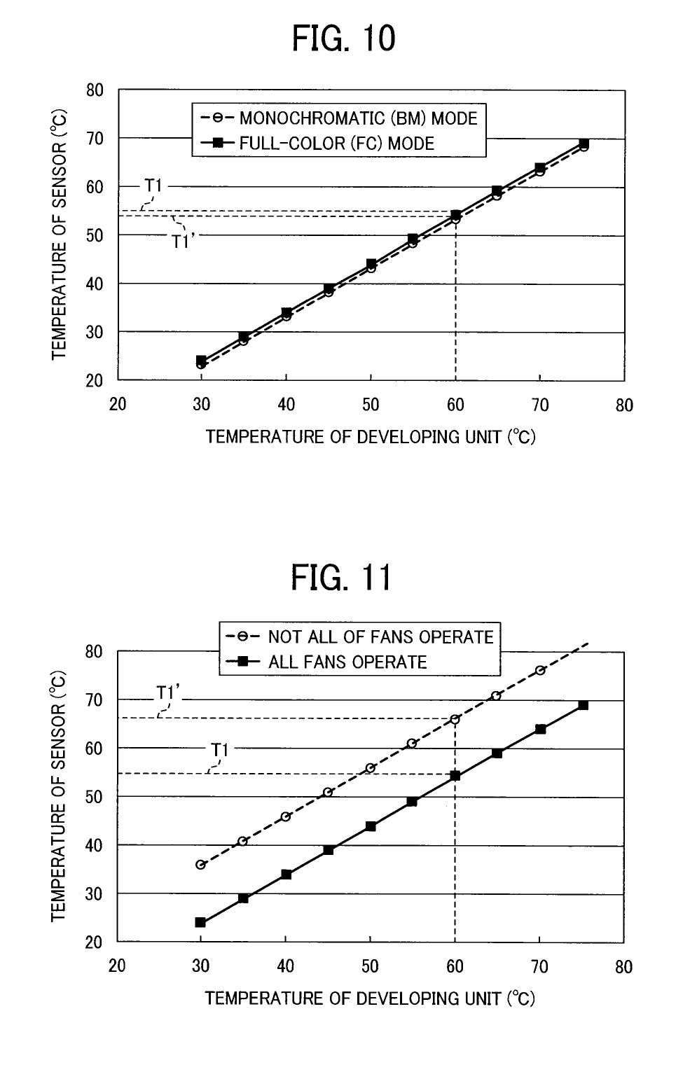

FIG. 10 is a graph that illustrates an aspect of relations between temperature detected by the temperature sensor 905 and that of the developing unit 7 differently obtained in a monochromatic mode (herein after referred to as a BW (Black and White) mode) and a full color mode (herein after referred to as a FC (full-color) mode) from each other. Usually, fusing temperature is higher and a larger number of driving motors is operated in the FC mode when the FC and BW modes are compared. For this reason, interior temperature of the printer frequently becomes relatively higher in the FC mode.

Further, as also shown there, the relations between detection temperature of the temperature sensor 905 and that of the developing unit 7 obtained in the respective FC and BW modes are slightly different from each other. In this regard, when the current mode is switched to the intermittent printing mode (i.e., mode transition control is practiced) to decrease the temperature of the develop unit 7 to be less than sixty degrees Celsius, the value T1 as shown in FIG. 10 is set to the above temperature threshold T1 in the FC mode. By contrast, in the BW mode, the value T1′ slightly smaller than the value T1 shown in FIG. 10 is set to the above-described temperature threshold T1 in the BW mode. Hence, an impact of the detection error of the temperature sensor 905 caused in accordance with a difference between the FC and BW modes can be effectively minimized.

Further, a temperature rising aspect in the developing unit 7 also becomes different in accordance with a ratio of usage of the FC or BW mode to the entire operation mode. In this respect, a usage ratio of the BW or FC mode is preferably sought based on a prescribed number of recording sheets recently produced. For example, a percentage of the number of recording sheets printed in the BW mode to the prescribed number of recording sheets is sought, and the above-described setting value to be set to the temperature threshold T1 may be switched in accordance with its usage ratio. Hence, an impact of the detection error of the temperature sensor 905 caused in accordance with the usage ratio of the BW or FC mode can be likely minimized.

Similar to the situation as described with reference to FIG. 9, relations between the temperature detected by the temperature sensor 905 and that of the developing unit 7 obtained in duplex and simplex modes are different from each other. Thus, the above-described setting value to be set to the temperature threshold T1 utilized in determining if a current mode is to be switched to the above-described intermittent printing operation mode may be switched in accordance with selection of one of the duplex and simplex modes.

For example, as similar to the previously described situation with reference to FIG. 9, the temperature threshold T1 (T1′) is set to the y′ when the simplex mode runs (i.e., during a simplex printing time). By contrast, the value T1 is set to y″ when the duplex mode runs (i.e., during a duplex printing time). Hence, an impact of the detection error of the temperature sensor 905 caused in accordance with selection of one of the simplex and duplex modes can be likely minimized.

Further, temperature rising caused in the developing unit 7 also changes in accordance with a ratio of outputs of recording sheets generated in each of the respective one sided and double-sided printing operations to the entire outputs. Specifically, temperature rising causing in the developing unit 7 changes in accordance with a ratio of usage of the duplex or simplex mode to the entire modes. In this respect, the ratio of usage of the duplex or simplex mode to the entire modes is preferably sought based on a prescribed number of recording sheets recently produced. For example, a usage ratio of double-sided printing or duplex mode, which is a percentage of the number of records printed on both sides in duplex mode to a given (total) number of recording sheets is sought, and the above-described setting value set to the temperature threshold T1 may be switched in accordance with the percentage of the usage. Hence, an impact of the detection error of the temperature sensor 905 caused in accordance with the usage percentage of the duplex or simplex mode can be likely minimized in such a situation.

More specifically, the double-sided printing ratio (i.e., a duplex mode usage ratio) is sought based on the latest 1000 sheets. When the duplex printing ratio is a %, it is substituted into the formula to calculate as y″′=((100−a)/100)×y′+(a/100)×y″. The value y″′ thus obtained by calculation of the formula is then set to the temperature threshold T1 to be utilized in determining if it is necessary to change the current mode to the above-described intermittent printing operation mode.

FIG. 11 is a graph that also illustrates an aspect when relations between a temperature detected by the temperature sensor 905 and that of the developing unit 7 differently obtained in accordance with a difference in the number of fans currently running in the printer to generate airflow.

Specifically, when the temperature sensor 905 is apart far from the developing unit 7, airflow in the interior of the printer changes in accordance with the number of running fans. As a result, as also shown there, the relations between a temperature detected by the temperature sensor 905 and that of the developing unit 7 are different from each other. In this regard, the above-described setting value set to the temperature threshold T1 to be utilized in determining if it is necessary to change the current mode to the above-described intermittent printing operation mode may be switched in accordance with the number of running fans.

Hence, an impact of the detection error of the temperature sensor 905 caused in accordance with the number of running fans can be likely similarly minimized in such a situation.

Further, when the temperature sensor 905 is apart far from the developing unit 7, since airflow in the interior of the printer also changes in accordance with the number of rotations of the running fans, the relation between a temperature detected by the temperature sensor 905 and that of the developing unit 7 is different in accordance with the number of rotations of the running fans.

To deal with this, the above-described setting value set to the temperature threshold T1 to be utilized in determining if it is necessary to change the current mode to the above-described intermittent printing operation mode may be switched in accordance with the number of revolutions of the running fans.

Hence, an impact of the detection error of the temperature sensor 905 caused in accordance with the number of revolutions of the running fans can be likely minimized similarly even in such a situation.

Further, the relation between a temperature detected by the temperature sensor 905 and that of the developing unit 7 is different in accordance with the number of sheets produced from a printing target of the last one unit of a printing job.

To deal with this, the above-described setting value set to the temperature threshold T1 to be utilized in determining if it is necessary to change the current mode to the above-described intermittent printing operation mode may be switched in accordance with the number of sheets produced from the printing target in the last one unit of printing job.

Hence, an impact of the detection error of the temperature sensor 905 caused in accordance with the number of sheets produced from a printing target in the last one unit of a printing job can be similarly likely minimized in such a situation.

Further, the relation between a temperature detected by the temperature sensor 905 and that of the developing unit 7 is different in accordance with a line velocity (i.e., a surface moving velocity) of each of the photoconductive members 3Y, 3C, 3M, and 3K provided in the printer.

To deal with this, the above described setting value set to the temperature threshold T1 to be utilized in determining if it is necessary to change the current mode to the above-described intermittent printing operation mode may be switched in accordance with the line velocity (i.e., a surface moving velocity) of each of the photoconductive members 3Y, 3C, 3M, and 3K provided in the printer.

Hence, an impact of the detection error of the temperature sensor 905 caused in accordance with the line velocity of each of the photoconductive members 3Y, 3C, 3M, and 3K provided in the printer can be similarly likely minimized in such a situation.

Further, the above-described multiple switching control manners of switching the temperature threshold T1 employed in the various embodiments can be randomly combined and applied to execute switching control. In such a situation, data of the relations between the temperature detected by the temperature sensor 905 and that of the developing unit 7 are generated and a table listing appropriate temperature thresholds T1 may be formed per combination of the switching control manners. Otherwise, positive and negative correction amounts can be simply added to the temperature threshold T1 for various conditions.

According to one typical embodiment of the present invention, interior or ambient temperature of the developing device, which correspondingly changes to that of the developer bearer, is detected, and transition or cancellation of intermittent image forming operation allowed to continuously form images on a prescribed limited number of sheets is executed in accordance with the detection result.

When it is determined in accordance with the detection result that a developer carrier has been overheated, the intermittent image forming operation, in which continuous image formation is made on the limited number of sheets, is executed, so that the developer carrier stops operation to be able to prevent excessive temperature rising. With this, interior or ambient temperature of the developing device, which correspondingly changes to that of the developer bearer, is detected, and transition or cancellation of an intermittent image forming operation, in which images are continuously formed only on the limited number of sheets in accordance with the detection result. Accordingly, developer can likely avoid melting on the developer-bearer due to such overheating of the developer-bearer.

By contrast, when it is not determined in accordance with the detection result that a developer carrier has been overheated, the above-described intermittent image forming operation is cancelled.

Accordingly, because the image forming operation is continuously executable without stopping the operation of the developer carrier, inefficient performance can be likely suppressed during the continuous image formation.

Moreover, by using the result of detecting temperature inside or near the developing device, which changes in accordance with the temperature of the developer carrier, when executing and cancelling the above-described intermittent image forming operation. Accordingly, temperature of the developer and the developer carrier in the developer unit may not be calculated and estimated.

Further, in accordance with ambient temperature affecting a cooling velocity of cooling the developing image forming apparatus with the developer carrier, a length of a braking time period for cooling the developer for carrier without executing image formation in the above-described intermittent image forming operation is varied. Thus, inefficient performance can be likely suppressed to the minimum during the continuous image formation without occurrence of melting of the developer on the developer-bearer due to the overheating of the developer-bearer in accordance with the ambient temperature.

Accordingly, temperature of the developer and the developer carrier in the developer unit may not be calculated and estimated on one hand, and occurrence of melting of the developer on the developer-bearer due to the overheating of the developer-bearer in accordance with the ambient temperature can be likely suppressed on the other hand. At the same time, inefficient performance can be likely suppressed to the minimum during the continuous image formation in accordance with the ambient temperature.

The present invention described heretofore is just one example, and at least has a unique advantage per embodiment as follows.

That is, according to one aspect (e.g. the first embodiment) of the present invention, an image forming apparatus is capable of executing continuous image forming operation forming images on more than one page, and includes a latent image forming device to form a latent image on an image bearer, a developer bearer to bear developer, and a developing device to develop the latent image borne on the image bearer with developer borne on the developer bearer. A temperature detector is provided to detect internal or surrounding temperature of the developing device correspondingly changing to temperature of the developer bearer. A temperature information-acquiring device is provided to acquire information of ambient temperature outside of the image forming apparatus. A controller is provided to either switch a current operation mode to an intermittent image forming operation mode allowed to execute intermittent image forming operation including a braking time period not to allow the image formation or cancel the intermittent image forming operation mode in accordance with detection result of the temperature detector. The intermittent image forming operation mode is allowed to execute continuous image formation only to produce images on a prescribed limited number of sheets. The intermittent image forming operation mode is allowed to execute continuous image formation only on a prescribed limited number of sheets. The controller varies the braking time period in accordance with the ambient temperature detected by the temperature information-acquiring device. With this, interior or ambient temperature of the developing device, which correspondingly changes to that of the developer bearer, is detected, and transition or cancellation of an intermittent image forming operation, in which images are continuously formed only on the limited number of sheets in accordance with the detection result. When it is determined in accordance with the detection result that a developer carrier has been overheated, the intermittent image forming operation, in which continuous image formation is made on the limited number of sheets, so that the developer carrier stops operation to be able to prevent excessive temperature rising. Accordingly, developer can likely avoid melting on the developer-bearer due to such overheating of the developer-bearer.

By contrast, when it is not determined in accordance with the detection result that a developer carrier has been overheated, the above-described intermittent image forming operation is cancelled. Accordingly, because the image forming operation is continuously executable without stopping the operation of the developer carrier, inefficient performance can be likely suppressed during the continuous image formation.

Moreover, by using result of detecting temperature inside or near the developing device, which changes in accordance with the temperature of the developer carrier when executing and cancelling the above-described intermittent image forming operation. Accordingly, temperature of the developer and the developer carrier in the developer unit may not be calculated and estimated. Further, in accordance with ambient temperature affecting a cooling velocity of cooling the developing device or the developer carrier, a length of a braking time period for cooling the developer or carrier while stopping image formation in the above-described intermittent image forming operation is varied. Thus, inefficient performance can be likely suppressed to the minimum during the continuous image formation while preventing occurrence of melting of the developer on the developer-bearer due to the overheating of the developer-bearer in accordance with the ambient temperature. Accordingly, temperature of the developer and the developer carrier in the developer unit may not be calculated and estimated on one hand, and melting of the developer on the developer-bearer due to the overheating of the developer-bearer in accordance with the ambient temperature can be likely suppressed on the other hand. At the same time, inefficient performance can be likely suppressed to the minimum during the continuous image formation in accordance with the ambient temperature.

According to another aspect of the present invention, the controller changes a current operation mode to the intermittent image forming operation mode when temperature T detected by the temperature detector exceeds a pre-set first temperature threshold T1. The intermittent image forming operation mode is allowed to execute continuous image formation on a prescribed limited number of sheets less than a given value P. The controller switches the intermittent image forming operation mode to a normal image forming operation mode allowed to execute continuous image formation on the limitless number of sheets when the temperature T detected by the temperature detector falls below a pre-set second temperature threshold T2 during the intermittent image forming operation mode. With this, as already described in the applicable embodiment, by controlling entering and cancelling the intermittent image forming operation mode in accordance with a result of comparison of temperature T detected by a temperature detector with each of the temperature thresholds T1 and T2, control becomes easier when compared with a situation in which a calculation result is utilized to estimate the temperature.

According to yet another aspect of the present invention, the controller changes the first temperature threshold T1 in accordance with the presence or absence of a peripheral device attachable to the image forming apparatus. With this, as already described in the applicable embodiment, an impact of the detection error of the temperature sensor caused in accordance with the presence or absence of the peripheral device can be effectively minimized. According to yet another aspect of the present invention, the controller starts a full color mode to form a full-color image and a monochromatic mode to form a monochromatic image. The controller changes the first temperature threshold T1 in accordance with selection of one of the monochromatic and full color modes. With this, as already described in the applicable embodiment, an impact of the detection error of the temperature sensor caused in accordance with a difference between the FC and BW modes can be effectively minimized.

According to yet another aspect of the present invention, the controller starts a simplex mode to form an image on one side of a recording medium and a duplex mode to form images on both sides of the recording medium, respectively. The controller changes the first temperature threshold T1 in accordance with selection of one of the simplex and the duplex modes. With this, as already described in the applicable embodiment, an impact of the detection error of the temperature sensor caused in accordance with the selection of one of the simplex and duplex modes can be likely minimized.

According to yet another aspect of the present invention, the controller changes the first temperature threshold T1 in accordance with the number of sheets counted per image formation in the last one image formation job. With this, as already described in the applicable embodiment, an impact of the detection error of the temperature sensor caused in accordance with the number of sheets produced from a printing target during the last one printing job.

According to yet another aspect of the present invention, more than one fan is provided to generate airflow in the image forming apparatus. The controller changes the first temperature threshold T1 in accordance with the number of running fans. With this, as already described in the applicable embodiment, an impact of the detection error of the temperature sensor caused in accordance with the number of running fans can be likely minimized.

According to yet another aspect of the present invention, when more than one fan is provided to generate airflow in the image forming apparatus, the controller changes the first temperature threshold T1 in accordance with the number of revolutions of the running fan per minutes. With this, as already described in the applicable embodiment, an impact of the detection error of the temperature sensor caused in accordance with the number of revolutions of the running fans creating the airflow can be minimized.

According to yet another aspect of the present invention, the controller changes the first temperature threshold T1 in accordance with a surface moving velocity of the image bearer. With this, as already described in the applicable embodiment, an impact of the detection error of the temperature sensor caused in accordance with the line velocity (i.e., a surface moving velocity) of each of the photoconductive members provided in the printer.

According to yet another aspect of the present invention, a magnitude relation between the first and second temperature thresholds T1 and T2 is represented by the inequality; T1>T2. With this, as already described in the applicable embodiment, melting of the toner can be likely prevented when the (normal) continuous image formation immediately starts after the limitation to the above-described continuous image formation on the prescribed limited number of sheets is cancelled and temperature of the developing device rapidly increases.

Numerous additional modifications and variations of the present invention are possible in light of the above teachings. It is therefore to be understood that within the scope of the appended claims, the present invention may be executed otherwise than as specifically described herein. For example, the order of steps for forming the image is not limited to the above-described various embodiments and can be likely appropriately changed.

What is claimed is:

1. An image forming apparatus for executing continuous image formation on more than one page, the image forming apparatus comprising:
a latent image forming device to form a latent image on an image bearer;
a developer bearer to bear developer;
a developing device to develop the latent image borne on the image bearer with developer borne on the developer bearer;
a temperature detector to detect internal or surrounding temperature of the developing device, the temperature changing with a temperature of the developer bearer;
a temperature information acquiring device to acquire information of ambient temperature outside of the image forming apparatus; and
a controller to either switch a current operation mode to an intermittent image forming operation mode that supports intermittent image formation including a braking time period during which image formation is prohibited or cancel the intermittent image forming operation mode in accordance with a detection result of the temperature detector, the intermittent image forming operation mode allowing continuous image formation only on a prescribed limited number of sheets,
wherein the controller varies the braking time period in accordance with the ambient temperature information acquired by the temperature information acquiring device.

2. The image forming apparatus as claimed in claim 1, wherein the controller switches the operation mode of the apparatus to the intermittent image forming operation mode when a temperature T detected by the temperature detector exceeds a pre-set first temperature threshold T1 to execute continuous image formation on a prescribed limited number of sheets less than a given value P, and switches the intermittent image forming operation mode back to a normal image forming operation mode to execute continuous image formation without a limitation to the number of sheets when the temperature T detected by the temperature detector falls below a pre-set second temperature threshold T2 during the intermittent image forming operation mode.

3. The image forming apparatus as claimed in claim 2, wherein the controller changes the first temperature threshold T1 depending on whether or not a peripheral device is attached to the image forming apparatus.

4. The image forming apparatus as claimed in claim 2, wherein the controller puts the apparatus in a full color mode to form a full-color image and a monochromatic mode to form a monochromatic image,
wherein the controller changes the first temperature threshold T1 in accordance with selection of one of the monochromatic and full color modes.

5. The image forming apparatus as claimed in claim 2, wherein the controller puts the apparatus in a simplex mode to form an image on one side of a recording medium and a duplex mode to form images on both sides of the recording medium, respectively,
wherein the controller changes the first temperature threshold T1 in accordance with selection of one of the simplex and the duplex modes.

6. The image forming apparatus as claimed in claim 2, wherein the controller changes the first temperature threshold T1 in accordance with the number of sheets counted per image formation in the last image formation job.

7. The image forming apparatus as claimed in claim 2, further comprising a plurality of fans to generate airflow in the image forming apparatus,
wherein the controller changes the first temperature threshold T1 in accordance with the number of fans in operation at any given time.

8. The image forming apparatus as claimed in claim 2, further comprising a plurality of fans to generate airflow in the image forming apparatus,
wherein the controller changes a setting value to be set to the first temperature threshold T1 in accordance with the number of revolutions per minute of the fans in operation at any given time.

9. The image forming apparatus as claimed in claim 2, wherein the controller changes the first temperature threshold T1 in accordance with a surface moving velocity of the image bearer.

10. The image forming apparatus as claimed in claim 2, wherein T1>T2.

11. A method for forming an image in an image forming apparatus, comprising the steps of:
forming a latent image on an image bearer;
bearing developer; developing the latent image borne on the image bearer with developer borne on a developer bearer;
detecting internal or surrounding temperature of the developing device changing corresponding to temperature of the developer bearer using a temperature detector;
acquiring information of ambient temperature outside of the image forming apparatus using a temperature information acquiring device;
switching an operation mode of the image forming apparatus to an intermittent image forming operation mode;
allowing intermittent image forming operation intermittently including a braking time period during which image formation in the intermittent image forming operation mode is prohibited;
continuously forming images on a prescribed limited number of sheets in the intermittent image forming operation mode;
varying the braking time period in accordance with the ambient temperature information acquired by the temperature information acquiring device; and
cancelling and switching the intermittent image forming operation mode to a normal operation mode to form images on a prescribed unlimited number of sheets in accordance with detection result of the temperature detector.

12. The method as claimed in claim 11, wherein the step of switching a current operation mode to the intermittent image forming operation mode is executed when a temperature T detected by the temperature detector exceeds a pre-set first temperature threshold T1,
wherein the step of continuously forming images in the intermittent image forming operation mode is executed on a prescribed limited number of sheets less than a given value wherein the step of switching the intermittent image forming operation mode to a normal image forming operation mode allowed to execute continuous image formation without a limitation to the number of sheets is executed when the temperature T falls below a pre-set second temperature threshold T2 during the intermittent image forming operation mode.

13. The method as claimed in claim 12, further comprising the step of changing the first temperature threshold T1,
wherein the step of changing the first temperature threshold T1 is executed depending on whether or not a peripheral device is attached to the image forming apparatus.

14. The method as claimed in claim 12, further comprising the step of changing the first temperature threshold T1,
wherein the step of changing the first temperature threshold T1 is executed in accordance with selection of one of monochromatic and full color modes to form a full-color image and a monochromatic image, respectively.

15. The method as claimed in claim 12, further comprising the step of changing the first temperature threshold T1,
wherein the step of changing the first temperature threshold T1 is executed in accordance with selection of one of simplex and duplex modes to form an image on one side and both sides of the recording medium, respectively.

16. The method as claimed in claim 12, further comprising the step of changing the first temperature threshold T1,
wherein the step of changing the first temperature threshold T1 is executed in accordance with the number of sheets counted per image formation in the last image formation job.

17. The method as claimed in claim 12, further comprising the step of generating airflow with a plurality of fans in the image forming apparatus,
wherein the step of changing the first temperature threshold T1 is executed in accordance with the number of fans in operation at any given time.

18. The method as claimed in claim 12, further comprising the step of generating airflow with a plurality of fans in the image forming apparatus,
wherein the step of changing the first temperature threshold T1 is executed in accordance with the number of revolutions per minute of the fans in operation.

19. The method as claimed in claim 12, wherein the step of changing the first temperature threshold T1 is executed in accordance with a surface moving velocity of the image bearer.

20. The method as claimed in claim 12, wherein T1>T2.
